(19) United States
(12) Patent Application Publication
(10) Pub. No.: US 2025/0247909 A1
(43) Pub. Date: Jul. 31, 2025

(54) SUPPORT OF MULTIPLE CARRIERS IN AN ENERGY SAVING NETWORK

(71) Applicant: LENOVO (BEIJING) LIMITED, Beijing (CN)

(72) Inventors: Ran Yue, Beijing (CN); Lianhai Wu, Beijing (CN); Haiming Wang, Beijing (CN); Min Xu, Beijing (CN); Jing Han, Beijing (CN)

(21) Appl. No.: 18/855,776

(22) PCT Filed: Jun. 13, 2022
(86) PCT No.: PCT/CN2022/098438

§ 371 Date: Oct. 10, 2024

(51) Int. Cl. H04W 76/15; H04W 16/32; H04W 76/22

(52) U.S. Cl. CPC H04W 76/15; H04W 16/32; H04W 76/22

(57) ABSTRACT

Methods and apparatuses for ensuring traffic performance are disclosed. A UE comprises a processor; and a transceiver coupled to the processor, wherein, the processor is configured to receive, via the transceiver, a configuration of mapping restriction for a logical channel, and select the logical channel for a UL grant if the state associated with the UL grant satisfies the mapping restriction for the logical channel.

### FIELD

The subject matter disclosed herein generally relates to wireless communications, and more particularly relates to methods and apparatuses for support of multiple carriers in an energy saving network.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Media Access Control (MAC), Control Element (CE), logical channel prioritization (LCP), configured grant (CG), Downlink Control Information (DCI), carrier aggregation (CA), dual connectivity (DC), (NAS), primary cell (PCell), secondary cell (SCell), primary secondary cell (PSCell), conditional PSCell addition (CPA), conditional PSCell change (CPC), master cell group (MCG), secondary cell group (SCG), Packet Data Convergence Protocol (PDCP), Protocol Data Unit (PDU), Radio Link Control (RLC), radio bearer (RB), data radio bearer (DRB), Quality of Service (QoS), packet delay budget (PDB), information element (IE), synchronization signal block (SSB), transmission reception point (TRP).

A UE that supports the feature of network energy saving techniques may be referred to as new UE. A UE that does not support the feature of network energy saving techniques may be referred to as legacy UE. A cell that supports the feature of network energy saving techniques may be referred to as new cell. A cell that does not support the feature of network energy saving techniques may be referred to as legacy cell.

The new cell may have different states, e.g. non-sleep state and multiple sleep states.

However, in example scenarios including single-carrier and multi-carrier deployments, prioritization of different cells in different states is to be discussed.

This invention targets the above issue.

### BRIEF SUMMARY

Methods and apparatuses for ensuring traffic performance are disclosed.

In one embodiment, a UE comprises a processor; and a transceiver coupled to the processor, wherein, the processor is configured to receive, via the transceiver, a configuration of mapping restriction for a logical channel, and select the logical channel for a UL grant if the state associated with the UL grant satisfies the mapping restriction for the logical channel.

In some embodiment, the state associated with the UL grant is indicated in a DCI scheduling the UL grant or indicated in a configuration of a configured grant if the UL grant is the configured grant. In particular, the DCI or the configuration of the configured grant explicitly indicates the state associated with the UL grant, or implicitly indicates the state associated with the UL grant by longer or shorter interval between scheduling signaling and transmission or between transmission and feedback.

In some embodiment, the state associated with the UL grant is the state of a cell from which the UL grant is received. In particular, the state of the cell is identified by one of an indication of state transition, a broadcast message, on/off duration of the cell, reduced SSB or SSB less or normal SSB, and TRP on or off.

In some embodiment, the mapping restriction of the logical channel is a list of allowed states, the state associated with the UL grant satisfies the mapping restriction for the logical channel if the state associated with the UL grant is included in the list of allowed states.

In some embodiment, the mapping restriction of a logical channel is an allowed state, the state associated with the UL grant satisfies the mapping restriction for the logical channel if the state associated with the UL grant is the allowed state.

In some embodiment, the mapping restriction of a logical channel is an indication of whether an energy saving mode is allowed, the state associated with the UL grant satisfies the mapping restriction for the logical channel if the energy saving mode corresponding to the state associated with the UL grant matches the indication.

In another embodiment, a method performed by a UE comprises receiving a configuration of mapping restriction for a logical channel, and selecting the logical channel for a UL grant if the state associated with the UL grant satisfies the mapping restriction for the logical channel.

In still another embodiment, a base unit comprises a processor; and a transceiver coupled to the processor, wherein, the processor is configured to transmit, via the transceiver, a configuration of mapping restriction for a logical channel, wherein, the mapping restriction for the logical channel is used for selecting the logical channel for a UL grant associated with a state.

In some embodiment, the mapping restriction for the logical channel is a list of allowed state.

In some embodiment, the mapping restriction for the logical channel is an allowed state.

In some embodiment, the mapping restriction for the logical channel is an indication of whether an energy saving mode is allowed.

In yet another embodiment, a method performed by a base unit comprises transmitting a configuration of mapping restriction for a logical channel, wherein, the mapping restriction for the logical channel is used for selecting the logical channel for a UL grant associated with a state.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic flow chart diagram illustrating an embodiment of a method;

FIG. 2 is a schematic flow chart diagram illustrating a further embodiment of the method;

FIG. 3 is a schematic flow chart diagram illustrating another embodiment of a method;

FIG. 4 is a schematic flow chart diagram illustrating a further embodiment of the method; and

FIG. 5 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, 3GPP NR-U, NR Radio Access operating with shared spectrum channel access and so on. It is contemplated that along with the developments of network architectures and new service scenarios, all embodiments in the present application are also applicable to similar technical problems. Moreover, the terminologies recited in the present application may change, which should not affect the principle of the present application. Embodiments of the present disclosure can also be applied to unlicensed spectrum scenario.

To make description clearer, a few concepts are clarified.

A UE, e.g. in idle (e.g. RRC_IDLE) state, camps on a cell. It means that the UE can receive system information broadcasted by the base unit (e.g. gNB) that manages the cell. A UE, e.g. in connected (e.g. RRC_CONNECTED) state, is served by at least one cell. It means that, for each of the at least one cell, the UE communicates with the gNB that manages the cell.

The new cell, which supports the feature of network energy saving techniques, may be in non-sleep state (e.g. normal state, active state, etc) or in sleep state. A new cell is in sleep state means the new cell is in the state of low energy consumption. There could be multiple sleep states, for example micro sleep state, light sleep state, deep sleep state, etc (note that the name of each sleep state may be different from micro sleep state, light sleep state, and/or deep sleep state. For example, multiple sleep states may alternatively be low level sleep state, medium level sleep state, high level sleep state, etc). Each of the sleep states corresponds to a different level of energy consumption. The different level of energy consumption may be represented by different state transition time, or by different reference parameters or different configurations or different configuration periods, or by different levels of TX power, or by different levels of power consumption, or by different levels of resource allocation, etc. Each of different levels may be less than 100%. A new cell is in non-sleep state means the new cell can utilize the full level of energy. Correspondingly, the state transition time, or TX power, or power consumption, or resource allocation, etc in non-sleep state can be less than or equal to 100% or can be higher than the level in sleep state.

A first embodiment relates to ensuring traffic performance in an energy saving network.

Legacy UEs may access to a new cell (or multiple new cells). It means that a new cell can serve both new UEs and legacy UEs. In order to save energy, if there is no latency critical traffic arriving in the new UE, the new cell may respond to the new UE in a longer duration comparing to that legacy UE within the same cell, or comparing to the new UE with the latency critical traffic.

According to prior art, the UL grant scheduled or allocated by the network is per MAC entity, not per traffic. The MAC entity shall allocate the UL resources by UL grant to the logical channel(s) for a traffic when a new transmission is performed. In the condition that the delay requirement of the traffic is relatively high in the UE (e.g. new UE), if the UL resources for the purpose of saving energy are allocated to the UE, such UL resources may be allocated to the logical channel for the traffic with high delay requirement, since there is not restriction preventing the UL resources for the purpose of saving energy are allocated for the traffic with high delay requirement. Accordingly, the traffic with high delay requirement will be transmitted on unsuitable UL resources.

This problem exists in both single-carrier and multi-carrier scenarios.

Logical channel prioritization (LCP) procedure is applied whenever a new transmission is performed.

According to the first embodiment, a mapping restriction is added to the LCP procedure. An RRC configuration may control the LCP procedure by configuring a mapping restriction for each logical channel.

The mapping restriction for each logical channel can be (1) an “allowedstate-List” consisting of a list of allowed state(s), (2) an “allowedstate”, or (3) “nesallowed”.

A UL grant contains UL resources. The logical channel can be selected for the UL grant (i.e. the UL resources) if the state associated with the UL grant satisfies the mapping restriction configured to the logical channel.

The state associated with the UL grant may be explicitly or implicitly indicated. The indication can be indicated in the DCI scheduling the UL grant or in a configuration of a CG (configured grant). For example, when the state associated with the UL grant is indicated in the DCI or in the configuration of the CG, the state associated with the UL grant can be explicitly indicated as corresponding to energy saving mode or normal mode (i.e. not energy saving mode). On the other hand, if longer interval between scheduling signaling and transmission or between transmission and feedback is indicated in the DCI or in the configuration of the CG, the state associated with the UL grant is implicitly indicated as energy saving mode; while if shorter interval is indicated, the state associated with the UL grant is implicitly indicated as normal state. In addition, if the cell (e.g. new cell) only serves new UE, the state associated with the UL grant can be regarded as the same as the state of the cell. In this condition, the indication of the state of the cell can be regarded as implicitly indicating the state associated with the UL grant. The state of the cell can be indicated in one of the following manners. In a first manner, the state of the cell can be indicated by an indication of state transition, or a broadcast message. In a second manner, the state of the cell can be derived from or an on/off duration of the cell if the on/off duration of the cell is configured semi-statically. In a third manner, if a cell is configured as reduced SSB (which means the transmission and/or reception of SSB is reduced, e.g. by increased periodicity, or by on-demand transmission and/or reception, or by occupying fewer symbols) or SSB less (which means SSB is not transmitted and/or received) or TRP off, the state of the cell is implicitly indicated as corresponding to energy saving mode; and if a cell is configured as normal SSB or TRP on, the state of the cell is implicitly indicated as corresponding to normal mode.

When the mapping restriction is (1) an “allowedstate-List” consisting of a list of allowed state(s), the UL grant (i.e. the UL resources) may be allocated to each logical channel satisfying the condition that the state associated with the UL grant is included in the list of allowed state(s) of the logical channel. It means that the logical channels satisfying the following condition can be selected for each UL grant: the state associated with the UL grant is included in the configured list of allowed state(s) of each logical channel.

For a first example, the light sleep state is included in the “allowedstate-List” of a logical channel. The logical channel can be selected for the UL grant associated with an energy saving mode corresponding to the light sleep state (i.e. the light sleep state associated with the UL grant is included in the “allowedstate-List” of logical channel).

For a second example, the non-sleep state is included in the “allowedstate-List” of a logical channel (which implies that the light sleep state is not included in the “allowedstate-List” of the logical channel). The logical channel cannot be selected for the UL grant associated with an energy saving mode corresponding to the light sleep state (i.e. the light sleep state associated with the UL grant is not included in the “allowedstate-List” of logical channel).

The allowed state(s) listed in the “allowedstate-List” can be alternatively be replaced by different levels of energy savings, corresponding to different levels of energy saving gains or different levels of network sleeps or different levels of energy consumptions or different levels of energy efficiencies or different levels of latencies. For example, high level of energy saving may correspond to deep sleep state, medium level of energy saving may correspond to light sleep state, and low level of energy saving may correspond to micro sleep state.

When the mapping restriction is (2) an “allowedstate” which indicates an allowed state, the UL grant (i.e. the UL resources) may be allocated to each logical channel satisfying the condition that the state associated with the UL grant is the allowed state. It means that the logical channels satisfying the following condition can be selected for each UL grant: the state associated with the UL grant is the allowed state configured to each logical channel.

For example, the “allowedstate” of a logical channel is sleep state (which for example means any of deep sleep state, light sleep state and micro sleep state). The logical channel can be selected for the UL grant associated with an energy saving mode corresponding to any sleep state (e.g. light sleep state).

The mapping restriction may be (3) “nesallowed”, which indicates whether or not a network energy saving mode is allowed. The “nesallowed” can be set to ‘true’ or ‘false’. Alternatively, the “nesallowed” can be ‘false’ by default and may be set to ‘true’. Further alternatively, the “nesallowed” can be ‘true’ by default and may be set to ‘false’. The logical channel can be selected for the UL grant if the energy saving mode corresponding to the state associated with the UL grant matches the “nesallowed” of the logical channel.

When a logical channel is configured with the “nesallowed”, which is by default or set to ‘true’, the logical channel can be selected for the UL grant if the state associated with the UL grant corresponds to an energy saving mode. The logical channel cannot be selected for the UL grant if the state associated with the UL grant does not corresponds to an energy saving mode.

When a logical channel is configured with the “nesallowed”, which is by default or set to ‘false’, the logical channel cannot be selected for the UL grant if the state associated with the UL grant corresponds to an energy saving mode. The logical channel can be selected for the UL grant if the state associated with the UL grant does not corresponds to an energy saving mode.

A second embodiment is related to adding a SCell in the scenario of carrier aggregation (CA) or dual connectivity (DC) when potential sleep state(s) of the SCell is considered.

When carrier aggregation (CA) is configured, the UE only has one RRC connection with the network. At RRC connection establishment, re-establishment and handover, one serving cell provides the NAS mobility information, and at RRC connection re-establishment and handover, one serving cell provides the security input. The one serving cell is referred to as the primary cell (PCell). Depending on UE capabilities, secondary cells (SCells) can be configured to form a set of serving cells together with the PCell. The configured set of serving cells for a UE consist of one PCell and one or more SCells. In case of CA, a UE has only one MAC entity.

When dual connectivity (DC) is configured, the UE has to MAC entities. One MAC entity is used to connect to master cell group (MCG) which consists of a set of serving cells including a primary cell (PCell) and possibly one or more SCells. The other MAC entity is used to connect to secondary cell group (SCG) which consists of a set of serving cells including a primary secondary cell (PSCell) and possibly one or more SCells.

In both of CA and DC, SCell(s) can be added to or removed from the UE.

A brief introduction of conditional PSCell addition CPA and conditional PSCell change (CPC) is described as follows. Once the configured measurement condition(s) for the candidate target SpCell(s) is/are satisfied, the conditional PSCell addition (CPA) or conditional PSCell change (CPC) is executed. The state of the additional or changed PSCell can be indicated.

In legacy, a cell (e.g. SCell) can only have two alternate states, including active state (or activated state) and inactive state (or deactivated state). The SCell can be activated (i.e. set to active state or activated state) or deactivated (i.e. set to inactive state or deactivated state) by the signaling.

With the introduction of potential multiple states (e.g. non-sleep state and multiple sleep states), a SCell may be added to the UE for the purpose of energy saving. It is not enough to only set (e.g. activate or deactivate) the SCell to activated state or deactivated state when the SCell is added to the UE.

According to the second embodiment, upon configuration or modification or activation of the serving cells of the MCG or the serving cells of the MCG other than the PCell or the serving cells of the SCG or the serving cells of the SCG other than PSCell or a SCell or the serving cells, or reconfiguration in a conditional reconfiguration for CPA (Conditional PSCell Addition) or CPC (conditional PSCell change), the state of the serving cell can be set if the cell is a new cell.

The potential states of the serving cell can be but not limited to: activated state, sleep state or different levels of sleep states (for example, deep sleep state, light sleep state, micro sleep state), non-sleep state, deactivated state, dormant state, etc.

All potential states can be parallel. It means that the serving cell can be set to one of the potential states.

Alternatively, the states can be classified into two levels. For example, the sleep state or different levels of sleep state (for example, deep sleep state, light sleep state, micro sleep state) and/or non-sleep state can be subordinate states of any of activated state, deactivated state and dormant state. For example, if deep sleep state, light sleep state, micro sleep state and non-sleep state are subordinate states of activated state, then, a serving cell can be set to activated state and be further set to light sleep state.

If all potential states are parallel, the state of the SCell (which is a new cell) can be set to
(1) one of activated state, sleep state or different levels of sleep states (for example, deep sleep state, light sleep state, micro sleep state), non-sleep state, and deactivated state; or
(2) one of activated state, sleep state or different levels of sleep states (for example, deep sleep state, light sleep state, micro sleep state), non-sleep state, deactivated state, and dormant state; or
(3) one of activated state, sleep state or different levels of sleep states (for example, deep sleep state, light sleep state, micro sleep state), and non-sleep state.

If there are two levels of the potential states, after the state of the SCell (which is a new cell) is set to a state (e.g. activated state, deactivated state or dormant state) that has subordinate states, the state of the SCell can be further set. For example, the state of the SCell can be set to:
(4) activated state (which is the state that has subordinate states), and be further set to one of sleep state and non-sleep state (if there is only one sleep state), or be further set to one of different levels of sleep states (for example, deep sleep state, light sleep state, micro sleep state) and non-sleep state (if there are different levels of sleep states); or
(5) deactivated state (which is the state that has subordinate states), and be further set to one of sleep state and non-sleep state (if there is only one sleep state), or be further set to one of different levels of sleep states (for example, deep sleep state, light sleep state, micro sleep state) and non-sleep state (if there are different levels of sleep states); or
(6) dormant state (which is the state that has subordinate states), and be further set to one of sleep state and non-sleep state (if there is only one sleep state), or be further set to one of different levels of sleep states (for example, deep sleep state, light sleep state, micro sleep state) and non-sleep state (if there are different levels of sleep states).

An example IE of the above-described (4) can be:

| | |
|---|---|
| SCellConfig ::= | SEQUENCE { |
| sCellIndex | SCellIndex, |
| sCellConfigCommon | ServingCellConfigCommon |

| | |
|---|---|
| OPTIONAL, | -- Cond SCellAdd |

| | |
|---|---|
| sCellConfigDedicated | ServingCellConfig |

| | |
|---|---|
| OPTIONAL, | -- Cond SCellAddMod |

```
      ...,
      [[
```

| | |
|---|---|
| smtc | SSB-MTC |

| | |
|---|---|
| OPTIONAL | -- Need S |

```
      ]],
      [[
```

| | |
|---|---|
| sCellState-r16 | ENUMERATED {activated} |

| | |
|---|---|
| OPTIONAL, | -- Cond SCellAddSync |
| sleep state | ENUMERATED {non-sleep, low level sleep, |

medium level sleep, high level sleep}OPTIONAL, -- configured
when the SCell is a new cell

| | |
|---|---|
| secondaryDRX-GroupConfig-r16 | ENUMERATED {true} |

| | |
|---|---|
| OPTIONAL | -- Cond DRX-Config2 |

]]}

In the above example, a SCell is by default in deactivated state. It can be set as activated state, and be further set as one of non-sleep state, low level sleep state, medium level sleep state, high level sleep state.

The PCell or the PSCell (which is a new cell) can be set to: sleep state or different levels of sleep states (for example, deep sleep state, light sleep state, micro sleep state), and non-sleep state.

The example IE for setting the PCell is as follows:

| | |
|---|---|
| PCellState | ENUMERATED {non-sleep, low |

level sleep, medium level sleep, high level sleep} OPTIONAL, --
configured when the PCell is a new cell

The example IE for setting the PSCell is as follows:

| | |
|---|---|
| PSCellState | ENUMERATED {non-sleep, low |

level sleep, medium level sleep, high level sleep} OPTIONAL, --
configured when the PSCell is a new cell

As a whole, each of the SCell, PCell and PSCell (which is a new cell) can be set to at least sleep state or one of different levels of sleep states (for example, deep sleep state, light sleep state, micro sleep state), or non-sleep state.

Traditionally, a legacy serving cell (e.g. SCell, PCell or PSCell) can be activated or deactivated to a state (e.g. activated state or deactivated state) by an indication MAC CE (e.g. SCell Activation/Deactivation MAC CE for activating or deactivating the state of SCell).

With the introduction of sleep state or different levels of sleep states (for example, deep sleep state, light sleep state, micro sleep state) and non-sleep state, a new serving cell (e.g. SCell, PCell or PSCell) can be set to one of the potential states by MAC CE(s).

If all potential states are parallel, the new SCell can be set to one of the potential states by a state indication MAC CE. The number of bits for indicating the set state contained in the state indication MAC CE can be designed according to the number of the potential states. Generally, 3 bits are necessary for indicating 5 to 8 parallel potential states. For example, if the potential states include 5 states: activated state, deep sleep state, light sleep state, non-sleep state, and deactivated state, 3 bits are necessary for indicating one of the 5 potential states.

If there are two levels of the potential states, and sleep state or different levels of sleep states (for example, deep sleep state, light sleep state, micro sleep state) and non-sleep are subordinate states, the traditional indication MAC CE can be used to set the first level of states, if necessary. For example, the traditional indication MAC CE can set (e.g. activate or deactivate) the state of SCell to activated state or deactivated state. If the set state (e.g. activated state) has subordinate states (e.g. deep sleep state, light sleep state, micro sleep state, non-sleep state), an additional indication MAC CE containing 2 bits for indicating one of 4 subordinate sleep states can be used to further set the state.

The state indication MAC CE can be used to indicate the state of the new SpCell (which is PCell or PSCell). The number of bits for indicating the set state contained in the state indication MAC CE (for indicating the state of the new SpCell) can be designed according to the number of potential states for the new SpCell. For example, if potential states for the new SpCell include 4 states: deep sleep state, light sleep state, micro sleep state, and non-sleep, 2 bits are necessary for indicating one of the 4 potential states.

If one state indication MAC CE is used to indicate the states of multiple serving cells, the state indication for each serving cell can be arranged in octet in the one state indication MAC CE.

The state indication MAC CE can be identified by a MAC subheader with a new LCID.

If an SCell is configured with sCellState set to a state upon SCell configuration, or an SCell state transition related MAC CE is received transitioning the SCell to a state (where the state can be deactivated, for example, sleep state or different levels of sleep states (for example, deep sleep state, light sleep state, micro sleep state), non-sleep state or dormant state), and the UE is allowed to transmit or receive data or signaling, then, a timer (e.g. sCellDeactivationTimer) associated with the SCell starts or restarts.

Alternatively, if an SCell is configured with sCellState set to a state upon SCell configuration, or an SCell state transition related MAC CE is received transitioning the SCell to a state (where the state is not fully activated, for example, sleep state), and the UE is allowed to transmit or receive data or signaling, then, the timer (e.g. sCellDeactivationTimer) associated with the SCell stops.

A third embodiment relates to split bearer and PDCP duplication.

When a PDCP PDU is submitted to lower layer, the transmitting PDCP entity may be associated with at least two RLC entities (e.g. two RLC entities associated with different cells).

If the PDCP duplication is activated for the RB, then, the PDCP data PDU can be duplicated and submitted to the associated RLC entities activated for PDCP duplication.

If the PDCP duplication is deactivated for the RB, the split secondary RLC entity is configured, and the total amount of PDCP data volume and RLC data volume pending for initial transmission in the primary RLC entity and the split secondary RLC entity is equal to or larger than ul-DataSplitThreshold, then, the PDCP PDU is submitted to either the primary RLC entity or the split secondary RLC entity.

According to the third embodiment, the state of the cell (especially the potential sleep state(s) of the cell) associated with the RLC entity is considered in split bearer and PDCP duplication.

In particular, in the condition that the PDCP duplication is deactivated for the RB and the split secondary RLC entity is configured, if the total amount of PDCP data volume and RLC data volume pending for initial transmission in the primary RLC entity and the split secondary RLC entity is equal to or larger than a threshold (e.g. ul-DataSplitThreshold), then, the PDCP PDU is submitted to either the primary RLC entity or the split secondary RLC entity if the states of the cells associated with both the primary RLC entity and the split secondary RLC entity fulfil the performance requirement of the DRB, or the PDCP PDU is submitted to one of the primary RLC entity and the split secondary RLC entity associated with a cell in a state that is more active (e.g. shorter transition time) than the state of another cell associated with the other of the primary RLC entity and the split secondary RLC entity.

In the condition that the PDCP duplication is activated for the RB, whether the PDCP data PDU can be duplicated and submitted to the associated RLC entities activated for PDCP duplication depends on the state of the cells associated with the RLC entities.

A first rule: NG-RAN should ensure that at least one serving cell is activated for each activated RLC entity of the DRB and the state of the activated cell can fulfil the performance requirement of the DRB.

A second rule: if the state of each of the activated cells associated with the activated RLC entities of the DRB cannot fulfil the performance requirement of the DRB, the duplication for the DRB is deactivated.

A third rule: if the state of any activated cell associated with an activated RLC entity of the DRB cannot fulfil the performance requirement of the DRB, the activated cell is deactivated.

All the above rules can be applied to the autonomous or network based activation/deactivation of duplication.

Whether the state of a cell associated with the RLC entity fulfils the performance requirement of the DRB can be decided by referring to the configuration of the network or the first embodiment or the QoS of the traffic.

For example, the PDB is larger than a threshold #1, the medium (or light) level of sleep state or non-sleep state can be acceptable

For another example, the PDB is less than a threshold #2, the non-sleep state can be acceptable.

On the other side, if the cell associated with one of the RLC entities of a split bearer is in a sleep state (e.g. light sleep state, deep sleep state), the cell can be considered as not fulfilling the performance requirement of the DRB. It means that the data will not be delivered to the RLC entity associated with the cell in any sleep state.

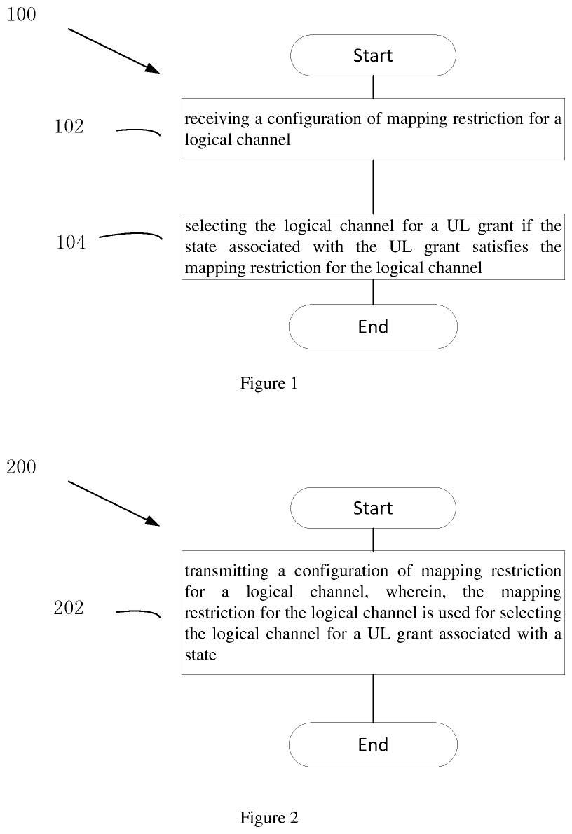

FIG. 1 is a schematic flow chart diagram illustrating an embodiment of a method 100 according to the present application. In some embodiments, the method 100 is performed by an apparatus, such as a remote unit (UE). In certain embodiments, the method 100 may be performed by a processor executing program code, for example, a microcontroller, a microprocessor, a CPU, a GPU, an auxiliary processing unit, a FPGA, or the like.

The method 100 may be performed by a UE and comprise 102 receiving a configuration of mapping restriction for a logical channel, and 104 selecting the logical channel for a UL grant if the state associated with the UL grant satisfies the mapping restriction for the logical channel.

In some embodiment, the state associated with the UL grant is indicated in a DCI scheduling the UL grant or indicated in a configuration of a configured grant if the UL grant is the configured grant. In particular, the DCI or the configuration of the configured grant explicitly indicates the state associated with the UL grant, or implicitly indicates the state associated with the UL grant by longer or shorter interval between scheduling signaling and transmission or between transmission and feedback.

In some embodiment, the state associated with the UL grant is the state of a cell from which the UL grant is received. In particular, the state of the cell is identified by one of an indication of state transition, a broadcast message, on/off duration of the cell, reduced SSB or SSB less or normal SSB, and TRP on or off.

In some embodiment, the mapping restriction of the logical channel is a list of allowed states, the state associated with the UL grant satisfies the mapping restriction for the logical channel if the state associated with the UL grant is included in the list of allowed states.

In some embodiment, the mapping restriction of a logical channel is an allowed state, the state associated with the UL grant satisfies the mapping restriction for the logical channel if the state associated with the UL grant is the allowed state.

In some embodiment, the mapping restriction of a logical channel is an indication of whether an energy saving mode is allowed, the state associated with the UL grant satisfies the mapping restriction for the logical channel if the energy saving mode corresponding to the state associated with the UL grant matches the indication.

FIG. 2 is a schematic flow chart diagram illustrating a further embodiment of a method 200 according to the present application. In some embodiments, the method 200 is performed by an apparatus, such as a base unit or a network device. In certain embodiments, the method 200 may be performed by a processor executing program code, for example, a microcontroller, a microprocessor, a CPU, a GPU, an auxiliary processing unit, a FPGA, or the like.

The method 200 may be performed by a base unit and comprises 202 transmitting a configuration of mapping restriction for a logical channel, wherein, the mapping restriction for the logical channel is used for selecting the logical channel for a UL grant associated with a state.

In some embodiment, the mapping restriction for the logical channel is a list of allowed state.

In some embodiment, the mapping restriction for the logical channel is an allowed state.

In some embodiment, the mapping restriction for the logical channel is an indication of whether an energy saving mode is allowed.

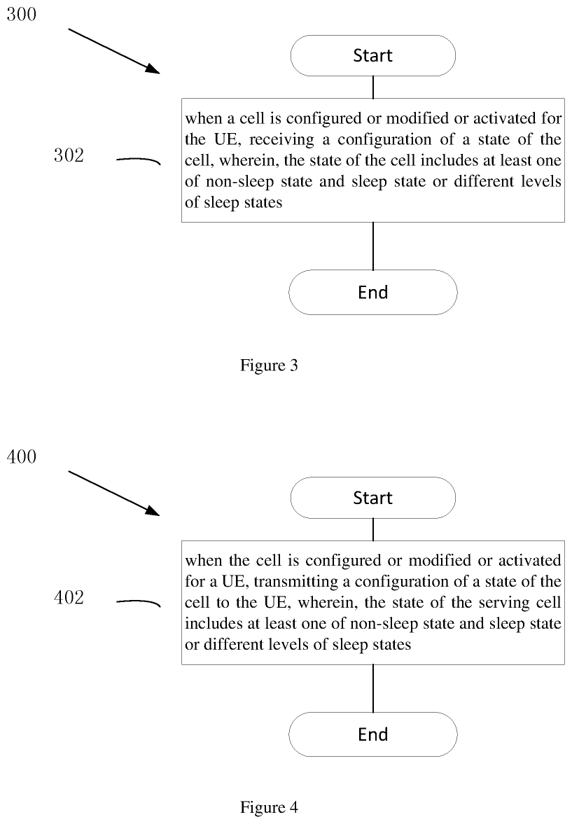

FIG. 3 is a schematic flow chart diagram illustrating an embodiment of a method 300 according to the present application. In some embodiments, the method 300 is performed by an apparatus, such as a remote unit (UE). In certain embodiments, the method 300 may be performed by a processor executing program code, for example, a microcontroller, a microprocessor, a CPU, a GPU, an auxiliary processing unit, a FPGA, or the like.

The method 300 may be performed by a UE and comprise 302 when a cell is configured or modified or activated for the UE, receiving a configuration of a state of the cell, wherein, the state of the cell includes at least one of non-sleep state and sleep state or different levels of sleep states.

In some embodiment, the method further comprises submitting a PDCP PDU associated with a DRB to a RLC entity if the state of the cell associated with the RLC entity fulfills the performance requirement of the DRB.

When a split secondary RLC entity is configured, the method comprises submitting the PDCP PDU to either a primary RLC entity or the split secondary RLC entity if the states of the cells associated with both the primary RLC entity and the split secondary RLC entity fulfil the performance requirement of the DRB.

In another embodiment, at least one cell is activated for each RLC entity, and the state of the activated cell fulfills the performance requirement of the DRB.

FIG. 4 is a schematic flow chart diagram illustrating a further embodiment of a method 400 according to the present application. In some embodiments, the method 400 is performed by an apparatus, such as a base unit or a network device. In certain embodiments, the method 400 may be performed by a processor executing program code, for example, a microcontroller, a microprocessor, a CPU, a GPU, an auxiliary processing unit, a FPGA, or the like.

The method 400 may be performed by a base unit and comprises 402 when the cell is configured or modified or activated for a UE, transmitting a configuration of a state of the cell to the UE, wherein, the state of the serving cell includes at least one of non-sleep state and sleep state or different levels of sleep states.

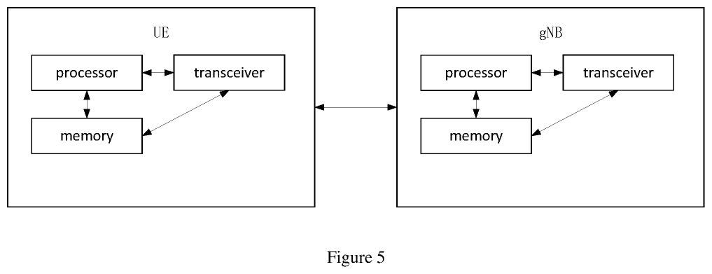

FIG. 5 is a schematic block diagram illustrating apparatuses according to one embodiment.

Referring to FIG. 5, the UE (i.e. remote unit, or terminal device) includes a processor, a memory, and a transceiver. The processor implements a function, a process, and/or a method which are proposed in FIG. 1.

The UE comprises a processor; and a transceiver coupled to the processor, wherein, the processor is configured to receive, via the transceiver, a configuration of mapping restriction for a logical channel, and select the logical channel for a UL grant if the state associated with the UL grant satisfies the mapping restriction for the logical channel.

In some embodiment, the state associated with the UL grant is indicated in a DCI scheduling the UL grant or indicated in a configuration of a configured grant if the UL grant is the configured grant. In particular, the DCI or the configuration of the configured grant explicitly indicates the state associated with the UL grant, or implicitly indicates the state associated with the UL grant by longer or shorter interval between scheduling signaling and transmission or between transmission and feedback.

In some embodiment, the state associated with the UL grant is the state of a cell from which the UL grant is received. In particular, the state of the cell is identified by one of an indication of state transition, a broadcast message, on/off duration of the cell, reduced SSB or SSB less or normal SSB, and TRP on or off.

In some embodiment, the mapping restriction of the logical channel is a list of allowed states, the state associated with the UL grant satisfies the mapping restriction for the logical channel if the state associated with the UL grant is included in the list of allowed states.

In some embodiment, the mapping restriction of a logical channel is an allowed state, the state associated with the UL grant satisfies the mapping restriction for the logical channel if the state associated with the UL grant is the allowed state.

In some embodiment, the mapping restriction of a logical channel is an indication of whether an energy saving mode is allowed, the state associated with the UL grant satisfies the mapping restriction for the logical channel if the energy saving mode corresponding to the state associated with the UL grant matches the indication.

The processor (of the UE) may also implement a function, a process, and/or a method which are proposed in FIG. 3.

The UE comprises a processor; and a transceiver coupled to the processor, wherein, the processor is configured to, when a cell is configured or modified or activated for the UE, receive, via the transceiver, a configuration of a state of the cell, wherein, the state of the cell includes at least one of non-sleep state and sleep state or different levels of sleep states.

In some embodiment, the method further comprises submitting a PDCP PDU associated with a DRB to a RLC entity if the state of the cell associated with the RLC entity fulfills the performance requirement of the DRB.

When a split secondary RLC entity is configured, the method comprises submitting the PDCP PDU to either a primary RLC entity or the split secondary RLC entity if the states of the cells associated with both the primary RLC entity and the split secondary RLC entity fulfil the performance requirement of the DRB.

In another embodiment, at least one cell is activated for each RLC entity, and the state of the activated cell fulfills the performance requirement of the DRB.

Referring to FIG. 5, the gNB (i.e. base unit or network device) includes a processor, a memory, and a transceiver. The processor implements a function, a process, and/or a method which are proposed in FIG. 2.

The base unit comprises a processor; and a transceiver coupled to the processor, wherein, the processor is configured to transmit, via the transceiver, a configuration of mapping restriction for a logical channel, wherein, the mapping restriction for the logical channel is used for selecting the logical channel for a UL grant associated with a state.

In some embodiment, the mapping restriction for the logical channel is a list of allowed state.

In some embodiment, the mapping restriction for the logical channel is an allowed state.

In some embodiment, the mapping restriction for the logical channel is an indication of whether an energy saving mode is allowed.

The processor (of the base unit) may also implement a function, a process, and/or a method which are proposed in FIG. 4.

The base unit comprises a processor; and a transceiver coupled to the processor, wherein, the processor is configured to, when the cell is configured or modified or activated for a UE, transmit, via the transceiver, a configuration of a state of the cell to the UE, wherein, the state of the serving cell includes at least one of non-sleep state and sleep state or different levels of sleep states.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A user equipment (UE), comprising:
at least one memory; and
at least one processor coupled with the at least one memory and configured to cause the UE to:
in response to a cell being configured, modified, or activated for the UE, receive a configuration of a state of the cell;
wherein the state of the cell includes at least one of a non-sleep state and a sleep state or different levels of sleep states.

15. The UE of claim 14, wherein the at least one processor is configured to cause the UE to submit a packet data convergence protocol (PDCP) protocol data unit (PDU) associated with a data radio bearer (DRB) to a radio link control (RLC) entity if the state of the cell associated with the RLC entity fulfills a performance requirement of the DRB.

16. The UE of claim 14, wherein, in response to a split secondary radio link control (RLC) entity being configured, the at least one processor is configured to cause the UE to submit a packet data convergence protocol (PDCP) protocol data unit (PDU) to either a primary RLC entity or the split secondary RLC entity if the states of the cells associated with both the primary RLC entity and the split secondary RLC entity fulfil a performance requirement of a data radio bearer (DRB).

17. The UE of claim 14, wherein at least one cell is activated for each radio link control (RLC) entity, and a state of an activated cell fulfills a performance requirement of a data radio bearer (DRB).

18. The UE of claim 14, wherein the sleep state is associated with a configuration period, a level of resource allocation, or both.

19. A processor for wireless communication, comprising:
at least one controller coupled with at least one memory and configured to cause the processor to:
in response to a cell being configured, modified, or activated for a user equipment (UE), receive a configuration of a state of the cell;
wherein the state of the cell includes at least one of a non-sleep state and a sleep state or different levels of sleep states.

20. The processor of claim 19, wherein the at least one controller is configured to cause the processor to submit a packet data convergence protocol (PDCP) protocol data unit (PDU) associated with a data radio bearer (DRB) to a radio link control (RLC) entity if the state of the cell associated with the RLC entity fulfills a performance requirement of the DRB.

21. The processor of claim 19, wherein, in response to a split secondary radio link control (RLC) entity being configured, the at least one controller is configured to cause the processor to submit a packet data convergence protocol (PDCP) protocol data unit (PDU) to either a primary RLC entity or the split secondary RLC entity if the states of the cells associated with both the primary RLC entity and the split secondary RLC entity fulfil a performance requirement of a data radio bearer (DRB).

22. The processor of claim 19, wherein at least one cell is activated for each radio link control (RLC) entity, and a state of an activated cell fulfills a performance requirement of a data radio bearer (DRB).

23. The processor of claim 19, wherein the sleep state is associated with a configuration period, a level of resource allocation, or both.

24. A method performed by a user equipment (UE), the method comprising:
in response to a cell being configured, modified, or activated for the UE, receiving a configuration of a state of the cell;
wherein the state of the cell includes at least one of a non-sleep state and a sleep state or different levels of sleep states.

25. The method of claim 24, further comprising submitting a packet data convergence protocol (PDCP) protocol data unit (PDU) associated with a data radio bearer (DRB) to a radio link control (RLC) entity if the state of the cell associated with the RLC entity fulfills a performance requirement of the DRB.

26. The method of claim 24, further comprising, in response to a split secondary radio link control (RLC) entity being configured, submitting a packet data convergence protocol (PDCP) protocol data unit (PDU) to either a primary RLC entity or the split secondary RLC entity if the states of the cells associated with both the primary RLC entity and the split secondary RLC entity fulfil a performance requirement of a data radio bearer (DRB).

27. The method of claim 24, wherein at least one cell is activated for each radio link control (RLC) entity, and a state of an activated cell fulfills a performance requirement of a data radio bearer (DRB).

28. The method of claim 24, wherein the sleep state is associated with a configuration period, a level of resource allocation, or both.

29. A base station, comprising:
at least one memory; and
at least one processor coupled with the at least one memory and configured to cause the base station to:
in response to a cell being configured, modified, or activated for a user equipment (UE), transmitting a configuration of a state of the cell;
wherein the state of the cell includes at least one of a non-sleep state and a sleep state or different levels of sleep states.

30. The base station of claim 29, wherein at least one cell is activated for each radio link control (RLC) entity, and a state of an activated cell fulfills a performance requirement of a data radio bearer (DRB).

31. The base station of claim 29, wherein the sleep state is associated with a configuration period, a level of resource allocation, or both.
